(19) United States
(12) Patent Application Publication
(10) Pub. No.: US 2015/0142171 A1
(43) Pub. Date: May 21, 2015

(54) METHODS AND APPARATUS TO CALIBRATE AN ORIENTATION BETWEEN A ROBOT GRIPPER AND A CAMERA

(71) Applicants: Gang Li, Princeton, NJ (US); Yakup Genc, Dayton, NJ (US); Siddharth Chhatpar, Brookline, MA (US); Daniel Sacco, Hackettstown, NJ (US); Sandeep Naik, Mead, NJ (US); Alexander Gelbman, Florham Park, NJ (US); Roy Barr, Delaware, NJ (US)

(72) Inventors: Gang Li, Princeton, NJ (US); Yakup Genc, Dayton, NJ (US); Siddharth Chhatpar, Brookline, MA (US); Daniel Sacco, Hackettstown, NJ (US); Sandeep Naik, Mead, NJ (US); Alexander Gelbman, Florham Park, NJ (US); Roy Barr, Delaware, NJ (US)

(73) Assignee: SIEMENS HEALTHCARE DIAGNOSTICS INC., Tarrytown, NY (US)

(21) Appl. No.: 14/238,142

(22) PCT Filed: Aug. 10, 2012
(86) PCT No.: PCT/US12/50288

§ 371 Date: Jul. 3, 2014

Related U.S. Application Data
(60) Provisional application No. 61/522,343, filed on Aug. 11, 2011.

(51) Int. Cl. B25J 9/16

(52) U.S. Cl. CPC B25J 9/1692; Y10S 901/27; Y10S 901/31; Y10S 901/47
USPC 700/251; 901/27; 901/31; 901/47

(57) ABSTRACT

Disclosed are methods adapted to calibrate a robot gripper to a camera. The method includes providing a robot with a coupled moveable gripper, providing one or more cameras, providing a target scene having one or more fixed target points, moving the gripper and capturing images of the target scene at two or more imaging locations, recording positions in the gripper coordinate system for each of the imaging locations, recording images in a camera coordinate system, and processing the images and positions to determine a gripper-to-camera transformation between the gripper coordinate system and the camera coordinate system. The transformation may be accomplished by nonlinear least-squares minimization, such as the Levenberg-Marquardt method. Robot calibration apparatus for carrying out the method are disclosed, as are other aspects.

### RELATED APPLICATIONS

The present application claims priority to U.S. Provisional Patent Application No. 61/522,343 filed Aug. 11, 2011, and entitled “System And Method For Calibrating Multiple Stationary Cameras In Versacell,” the disclosure of which is hereby incorporated herein by reference in its entirety for all purposes.

### FIELD

The present invention relates generally to methods and apparatus adapted to calibrate a positional orientation of a robot component to a camera in systems for moving biological liquid containers.

### BACKGROUND

In medical testing and processing, the use of robotics may minimize exposure to, or contact with, bodily fluid samples (otherwise referred to as “specimens”) and/or may increase productivity. For example, in some automated testing and processing systems (e.g., clinical analyzers and centrifuges), sample containers (such as test tubes, sample cups, vials, and the like) may be transported to and from sample racks (sometimes referred to as “cassettes”) and to and from a testing or processing location or system.

Such transportation may be accomplished by the use of an automated mechanism, which may include a suitable robotic component (e.g., a moveable robot) having a moveable end effector that may have gripper fingers. The end effector may be moved in two or more coordinate directions. In this way, a sample container (containing a specimen to be tested or processed) may be gripped by the end effector, and then moved from one location to another in relationship to the testing or processing location or system. For example, the sample container may be moved to and from a receptacle of a sample rack.

Inaccurate calibration may result in inaccurate positioning of the end effector and may cause collisions or jams between the end effector and the sample container, and/or between the sample container being moved and the testing or processing system or sample rack. Additionally, inaccurate calibration may contribute to jarring pick and place operations of the sample container, which may contribute to unwanted specimen spillage.

Accordingly, methods and apparatus that may improve accuracy of positioning of a robot gripper relative to an article, such as a sample container (e.g., sample tube) in testing and processing systems are desired. Furthermore, methods that improve accuracy of positioning of gripper fingers of grippers are also desired.

### SUMMARY

In a method aspect, an improved method of calibrating a position of a gripper to a camera is provided. The method includes providing a robot having a coupled gripper, the gripper moveable in a gripper coordinate system; providing a camera moveable with the gripper; providing a target scene having one or more fixed target points in world coordinates; moving the gripper to two or more imaging locations in the gripper coordinate system relative to the one or more fixed target points of the target scene; recording a position of each of the imaging locations in the gripper coordinate system; capturing an image of the target scene with the camera at each imaging position in a camera coordinate system; and processing the images to determine a gripper-to-camera transformation between the gripper coordinate system and the camera coordinate system.

In an apparatus aspect, a robot calibration apparatus is provided. The robot calibration apparatus includes a robot having a gripper, the robot adapted to cause motion of the gripper in a gripper coordinate system; a target scene including one or more fixed target points; a camera moveable with the gripper and adapted to capture images of the target scene in a camera coordinate system; and a controller coupled to the camera and the robot, the controller adapted to process the images and positional information of the robot to determine a gripper-to-camera transformation between the gripper coordinate system and the camera coordinate system.

In another method aspect, an improved method of calibrating a position of a gripper to a camera is provided. The method includes providing a robot having a coupled gripper moveable in a gripper coordinate system relative to a frame; providing one or more cameras in a fixed orientation to the frame; providing a target scene moveable with the gripper and having one or more fixed target points on the target scene; moving the gripper and the target scene to two or more imaging locations in the gripper coordinate system; recording a position in the gripper coordinate system for each of the imaging locations; capturing images of the one or more fixed target points of the target scene with the one or more cameras and recording images in a camera coordinate system; and processing the images to determine a gripper-to-camera transformation between the gripper coordinate system and the camera coordinate system.

In an apparatus aspect, a robot calibration apparatus is provided. The robot calibration apparatus includes a frame; a robot moveable relative to the frame and having a gripper, the robot adapted to cause motion of the gripper in a gripper coordinate system; a fixed target scene including one or more fixed target points moveable with the gripper; one or more cameras provided in a fixed orientation to the frame and adapted to capture images of the target scene in a camera coordinate system; and a controller coupled to the one or more cameras and the robot, the controller adapted to process the images and positional information of the robot to determine a gripper-to-camera transformation between the gripper coordinate system and the camera coordinate system.

Still other aspects, features, and advantages of the present invention may be readily apparent from the following detailed description by illustrating a number of exemplary embodiments and implementations, including the best mode contemplated for carrying out the present invention. The present invention may also be capable of other and different embodiments, and its several details may be modified in various respects, all without departing from the scope of the present invention. Accordingly, the drawings and descriptions are to be regarded as illustrative in nature, and not as restrictive. The drawings are not necessarily drawn to scale. The invention is to cover all modifications, equivalents, and alternatives falling within the scope of the invention.

### BRIEF DESCRIPTION OF THE DRAWINGS

FIG. 1 illustrates a side view of a robot calibration apparatus for a robot vision system having a moveable camera according to embodiments.

FIG. 2A illustrates a diagram of a target scene used during camera calibration according to embodiments.

FIG. 2B illustrates a stick diagram of various coordinate systems according to embodiments.

FIG. 2C illustrates a stick diagram with the gripper and camera positioned at several imaging locations according to embodiments.

FIG. 2D illustrates a diagram of pixel locations of target points in images captured from various imaging locations according to embodiments.

FIG. 3A illustrates a side view of an alternative robot calibration apparatus having one or more fixed cameras and a moving target scene according to embodiments.

FIG. 3B illustrates a top view of a disc including a target scene having multiple targets used during a camera calibration according to embodiments.

FIG. 3C illustrates a side view of the disc including a target scene of FIG. 3B.

FIG. 3D illustrates a stick diagram of a robot carrying the disc including a target scene of FIG. 3B.

FIG. 3E illustrates a stick diagram with the gripper and target scene positioned at several imaging locations according to embodiments.

FIG. 4 is a flowchart illustrating a method of calibrating a position of a gripper to a camera according to embodiments.

FIG. 5 is a flowchart illustrating an alternative method of calibrating a position of a gripper to a camera according to embodiments.

### DETAILED DESCRIPTION

In robotic apparatus, such as those used to accomplish robotic pick and place operations in clinical analyzers or other testing or processing systems, for the aforementioned reasons, achieving precision in the placement of gripper fingers of a gripper is desirable. “Gripper” as used herein is any member coupled to a robot (e.g., to a robot arm) that is used in robotic operations to grasp and/or move an article (e.g., a sample container) from one location to another, such as in a pick and place operation. In such robot apparatus, relatively high positional precision of the gripper may be desired. According to some embodiments of the invention, a vision system (e.g., camera and a controller) may be used to help direct and orient the gripper to a desired location in three-dimensional space. A prerequisite for multi-view stereo processing is to estimate a relative pose between the gripper and the camera, which is a fixed 3D transformation. Accordingly, exacting calibration between the vision system (e.g., the camera) and the gripper may be desirable. Therefore, according to embodiments, methods and apparatus to calibrate a camera to a gripper are provided.

In view of the foregoing, embodiments of the present invention provide calibration methods and apparatus to readily determine an actual position of a gripper of a robot relative to a camera of a vision system.

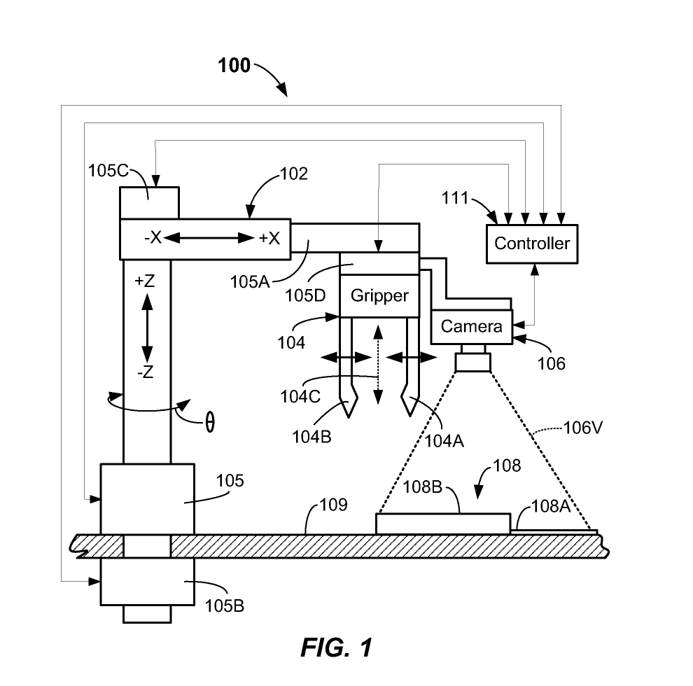

These and other aspects and features of the invention will be described with reference to FIGS. 1-5 herein.

In accordance with a first apparatus embodiment of the invention, as best shown in FIG. 1, a robot calibration apparatus 100 and calibration is described. The robot calibration apparatus 100 includes a robot 102 that is useful for grasping a sample container, such as blood collection vessel, sample cup, or the like, at a first location and transferring the sample container to a second location. The robot 102 may be used in a diagnostic machine such as an automated clinical analyzer, centrifuge, or other processing or testing system (e.g., a biological fluid specimen processing or testing system). The robot 102 has a gripper 104 coupled to a moveable part of the robot 102 (e.g., to a robot arm 105A thereof). The gripper 104 may include two or more moveable fingers 104A, 104B that are relatively moveable to one another and adapted to grasp articles, such as sample containers (e.g., sample tubes). The gripper fingers 104A, 104B may be driven to open and close along any suitable direction in an X-Y plane (e.g., in the X or Y direction or combinations thereof). The Y is into and out of the paper as shown. The open and close may be accomplished by any suitable finger drive apparatus, such as an electric, pneumatic, or hydraulic servo motor, or the like. Other suitable mechanisms for causing gripping action of the fingers 104A, 104B may be used. Furthermore, although two fingers are shown, the present invention is equally applicable to a gripper 104 having more than two gripper fingers. Other gripper types may be used, as well. The robot 102 may be any suitable robot capable of moving the gripper 104 in space (e.g., three-dimensional space).

The robot 102 may, for example, have a rotational motor 105 adapted to rotate a robot arm 105A to a desired angular orientation in a rotational direction θ. The robot 102 may also include a translational motor 105B that may be adapted to move the gripper 104 in a vertical direction (e.g., along a +/−Z direction as indicated by the arrow). Optionally, the robot 102 may include an X translation motor 105C adapted to impart translational motion of the gripper 104 along the robot arm 105A (e.g., along the +/−X direction). The X translation may be provided by a telescopic member, wherein the robot arm 105A has a telescopic motion relative to a second member coupled to the X translation motor 105C, for example. However, other suitable robot motors and mechanisms for imparting X, θ, and/or Z motion or other combinations of motion may be provided. Suitable feedback mechanisms may be provided for each degree of motion (X, θ, and/or Z) such as from position and/or rotation encoders or sensors.

In one or more embodiments, the robot 102 may be used to accomplish three-dimensional coordinate motion (X, θ, and Z) of the gripper 104 so that sample containers may be placed in or removed from a receptacle of a sample rack or placed in or removed from other positions in testing or processing equipment. Additionally, the robot 102 may accomplish a rotation of the gripper 104 about axis 104C, so that the fingers 104A, 104B may be precisely rotationally oriented relative to a sample container (not shown). The robot 102 may include a T axis motor 105D adapted to impart T axis rotational motion about the axis 104C to the gripper fingers 104A, 104B.

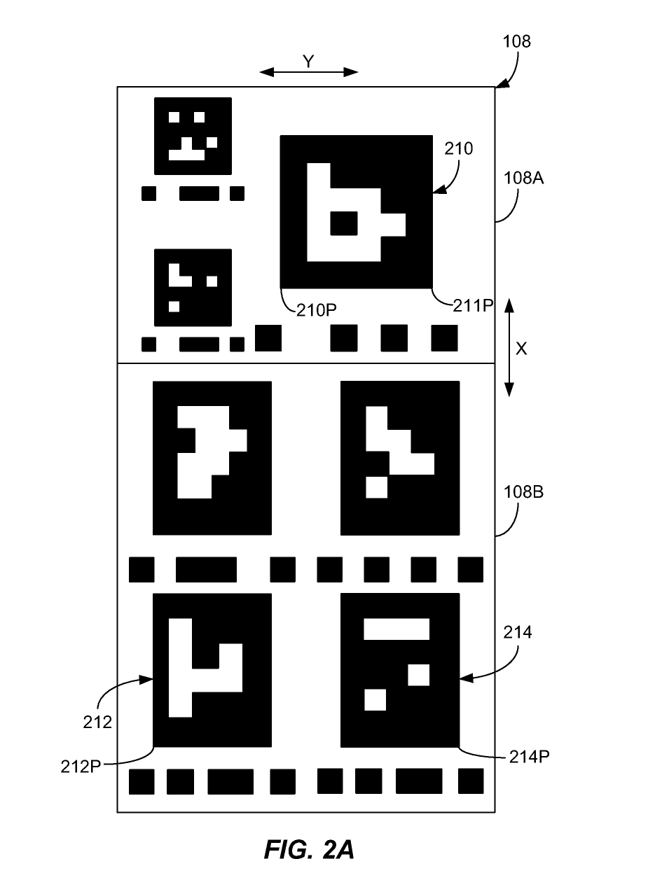

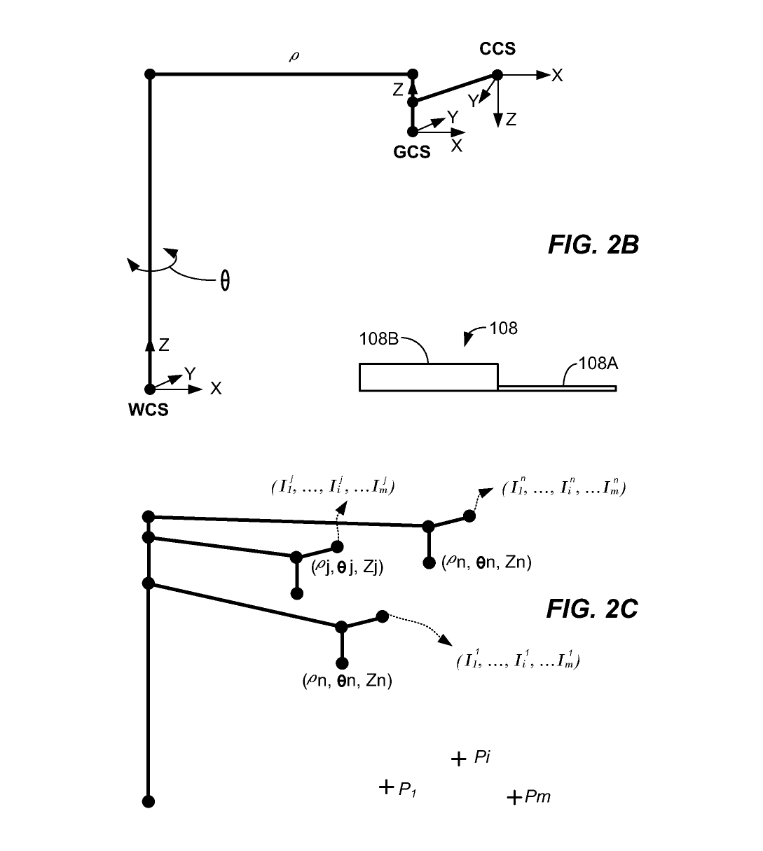

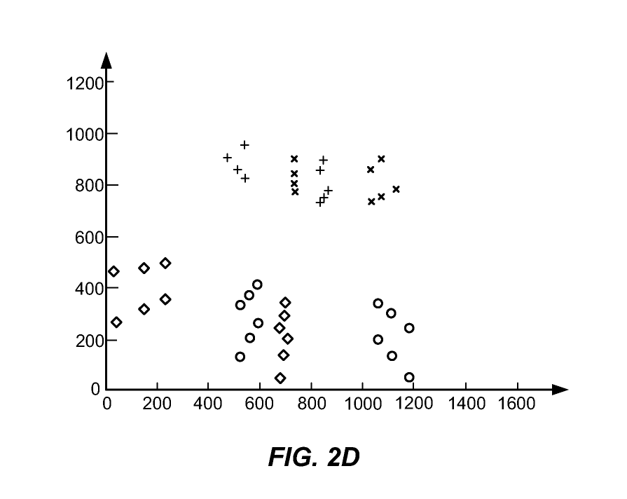

The robot 102 may include suitable tracks or guides and suitable motors, such as one or more stepper motors, one or more servo motors, one or more pneumatic or hydraulic motors, one or more electric motors, or combinations thereof. Furthermore, drive systems including chains, guides, racks, pulleys and belt arrangements, gear or worm drives or other conventional drive components may be utilized to cause the various motions of the gripper 104. Other types of robots may be employed. The robot 102 is adapted to cause motion of the gripper 104 in an X, Y, and/or Z direction in a gripper coordinate system (GCS) as shown in FIG. 2B.

Coupled to the gripper 104 or to a portion of the robot 102 (e.g., robot arm 105A) in a vicinity of the gripper 104 is a camera 106. The camera 106 may be part of a vision system adapted to guide the gripper 104 to an appropriate position and orientation in order to carry out a task. The task may be a pick or place operation of a sample container. The camera 106 may be any suitable digital camera. For example, the camera 106 may be a C905 webcam available from Logitech, for example. Other digital camera types may be used. The camera 106 may be oriented to have a field of view that is below the gripper 104 such that the camera 106 is part of the vision system for positioning and orienting the gripper 104. Furthermore, although only one camera 106 is shown in FIG. 1, other embodiments may utilize a plurality of moveable cameras 106 in order to capture multiple images, which may enlarge the field of view. More cameras 106 may also minimize the amount of movement for calibration.

As shown in FIGS. 1 and 2A, the robot calibration apparatus 100 includes a target scene 108. In the depicted embodiment, the camera 106 is moveable with the gripper 104 and is adapted to capture multiple images of the target scene 108 in a camera coordinate system CCS as shown in FIG. 2B. As shown, the target scene 108 is provided within a field of view 106V of the camera 106. The target scene 108 may be placed at a known physical location in X, Y, and Z coordinates in a world coordinate system WCS as shown in FIG. 2B. The target scene 108 may also be provided within a reach of the robot arm 105A. In some embodiments, several locations on the target scene 108 may be sensed by a tool provided in the gripper 104 to establish the X, Y, and Z coordinates of various target points of the target scene 108.

The target scene 108 may be any suitable scene (e.g., geometric pattern) that may contain one or more fixed targets, such as fixed targets 210, 212, 214 (FIG. 2A). The target scene 108 may be a marker board in some embodiments. The fixed targets 210, 212, 214 may include geometric shapes that have suitable contrast relative to a background, for example. For example, black and white shapes may be used that have a series of edges (e.g., lines) whose locations may be easily obtained and determined by conventional image analysis techniques. For example, a blob analysis may be used to create masks and identify various lines, edges, or corners in the images captured by the camera 106. The fixed targets 210, 212, 214 may be Hoffman markers, for example.

In some embodiments, the target scene 108 having the fixed targets 210, 212, 214 may include one or more fixed target points, such as fixed target points 210P, 211P, 212P, and 214P. For example, as shown in FIG. 2A, the target scene 108 may be a series of individual fixed targets 210, 212, 214 that are spaced about one or more X-Y planes. Each fixed target 210, 212, 214 may have one or more target points thereon. For example, target 210 includes spaced target points 210P, 211P located at the two lower corners thereof. The location of the target points in X, Y, Z space in the world coordinate system WCS is known. The corner locations in the camera coordinate system CCS may be readily found and identified in the captured images by blob analysis. Each target 210, 212, 214 may include shapes including edges that intersect to define the fixed target points 210P, 211P, 212P, 214P. For example, the targets 210, 212, 214 may have shapes and/or edges oriented in an X and Y direction that may be used to define the target points 210P, 211P, 212P, 214P. Targets 210, 212, 214 may include a black box with one or more white polygonal shapes contained therein.

The target scene 108 may be placed on a surface 109 provided underneath the gripper 104 and within the range of motion of the robot 102 and within the field of view of the camera 106. Additional targets may be provided to provide additional target points. For example, four or more, five or more, six or more, seven or more, or even a higher number of targets may be used.

In the depicted embodiment, the target scene 108 is provided at multiple vertical levels 108A, 108B in the Z direction (See FIG. 1 and FIG. 2A). The target scene 108 may comprise targets 210, 212, 214 that are printed on a substrate such as paper, and which are provided in a known location in the world coordinate system WCS (see FIG. 2B). The location of the targets 210, 212, 214 relative to the robot 102 may be known by physically orienting the target scene 108 in a known orientation and position relative to a known structure of the robot 102. Optionally, the location may be determined by seeking multiple locations on the targets 210, 212, 214 with the gripper 104 carrying a stylus or pointer whose end point location (e.g., tip location) relative to the tips of the gripper fingers 104A, 104B is known.

According to the calibration method, in one aspect thereof, the camera 106 is moveable with the gripper 104 and is adapted to capture multiple images of the target scene 108 in a camera coordinate system CCS (see FIG. 2B) from multiple image locations (e.g., viewpoints). The robot 102 may include feedback sensors to provide positional information concerning the position of the gripper 104 of the robot 102 in three-dimensional space at each image location. The calibration of the gripper 104 in the gripper coordinate system GCS to the world coordinate system WCS may be accomplished by any known calibration method. Such calibration may occur before attempting to carry out the calibration method of the camera 106 to the gripper 104.

According to an aspect of the calibration method, multiple images of one or more targets (e.g., targets 210, 212, 214) having one or more fixed target points (e.g., fixed target points 210P, 211P, 212P, 214P) thereon may be captured by the camera 106 at different imaging locations (e.g., viewpoints) by moving the robot 102 to multiple imaging locations and capturing images at each imaging location. For example, a first image of the target scene 108 may be captured at a first location in three-dimensional space at a first imaging location. The robot 102 and camera 106 may be moved to a second imaging location in three-dimensional space different than the first imaging location, and another image may be captured. In other embodiments, additional images at additional imaging locations in three-dimensional space different than the first and second imaging locations may be captured.

A controller 111 coupled to the camera 106 and the robot 102 is adapted to process the images (e.g., digital images) and the positional information received and stored about the location of the gripper 104 of the robot 102 when each image was taken in order to determine a gripper-to-camera transformation between the gripper coordinate system GCS and the camera coordinate system CCS. The controller 111 processes the data obtained at the two or more image locations from the position feedback (e.g., feedback encoders or sensors) and the location of the one or more target points 210P, 211P, 212P, 214P from the image analysis (e.g., blob analysis) to calculate the unknown gripper-to-camera transformation. The method may then apply a non-linear optimization technique to an error function of re-projection error to estimate the relative transformation between the gripper coordinate system GCS and the camera coordinate system CCS. The transformation may be solved using suitable nonlinear optimization techniques.

In accordance with an aspect of one or more embodiments of the invention, the robot 102 may be moved under the control of the controller 111 to defined imaging locations in three-dimensional space, such as two or more, three or more, four or more, five or more, ten or more, or even twelve or more locations. Other numbers of imaging locations may be used. The controller 111 may be any suitable controller adapted to interact with the robot 102, and may include a suitable microprocessor, memory, conditioning electronics, and circuitry adapted to carry out the robot motions, obtain and record positional information of the robot 102 at the imaging locations, perform the image analysis to obtain the target points in pixel space, and perform minimization calculations associated with the calibration of the gripper 104 to the camera 106.

The imaging locations in space may be above each of the targets 210, 212, and 214 of the target scene 108, for example. However, the imaging locations need not be directly over the targets 210, 212, and 214 and may be elsewhere within the reach of the robot 102 and field of view 106V of the camera 106. For example, the gripper 104 and camera 106 may be first located above target point 210 and a first image I1 from the first vantage point may be acquired. The image I1 may include all three targets 210, 212, 214 therein. The robot 102 and gripper 104 may be raised at least once vertically in the Z direction and a second image I2 may be captured at a second vantage point. Optionally, the robot 102 and gripper 104 may be raised again in the Z direction so that a third image I3 is captured. This sequence may be repeated above each remaining target 212, 214. Thus, a plurality of images (e.g., I1 through I12) may be captured, stored, and proceed by the controller 111 (e.g., using blob analysis or other point location extraction techniques) to obtain the physical locations of the target points 210P, 211P, 212P, 214P in pixel space for each target point 210P, 211P, 212P, 214P from each vantage point.

At each physical viewpoint location (e.g., image location), where the robot 102 places the gripper 104, the physical location coordinates (X, Y, Z) may be recorded in memory. Encoders of the robot 102, such as coupled to each of the motors 105, 105B, 105C, may provide precision feedback of positional information in the (X, θ, Z) gripper coordinate system. These physical locations in three-dimensional space may be recorded in memory of the controller 111. At each of these physical locations, a corresponding image of the target scene 108 is captured as described above. From these images, the target locations are determined and an estimate of the relative transformation between the gripper coordinate system GCS and the camera coordinate system CCS may be obtained. Once the calibration is completed, the gripper 104 may be positioned precisely relative to any article found and identified in the image field 106V of the camera 106. As previously stated, prior to calibration of the camera 106 to the gripper 104, the exact location of the gripper 104 and gripper fingers 104A, 104B within the world coordinate system WCS may be calibrated so that it may be precisely known.

In more detail, the goal of the present method is to recover the unknown rigid motion between the gripper coordinate system GCS and the camera coordinate system CCS. For an image location in space, if the robot parameter to reach this point is (X, θ, Z), then the origin of the gripper coordinate system GCS in the world coordinate system WCS is given by equation 1 below.

$${C}_{w} = [ \begin{matrix}X cos ( θ ) \\ X sin ( θ ) \\ z\end{matrix} ] \qquad Equation 1$$

By moving the robotic arm 105A of the robot 102, the controller 111 can measure and obtain positional information at multiple image points relative to the location of target scene 108, which are represented in the world coordinate system WCS from the robot positional information as shown above. These points are then imaged to obtain multiple images:

{I₁^{j}, . . . ,Iᵢ^{j}, . . . Iₘ^{j}}

when the robotic arm 105A moves to location with parameter

(Xⱼ,θⱼ,zⱼ)

for

j=1, . . . ,n.

FIG. 2C illustrates this movement of the gripper 104 and the camera 106 that is moveable therewith to multiple image points in (X, θ, Z) space. When the robot arm 105A moves the camera 106 to an image point with parameter (ρj, θj, Zj), the rigid transformation from the world coordinate system WCS to the gripper coordinate system GCS can be determined as:

$${R}_{wg}^{j} = [ \begin{matrix}cos ( {θ}_{j} ) & sin ( {θ}_{j} ) & 0 \\ - sin ( {θ}_{j} ) & cos ( {θ}_{j} ) & 0 \\ 0 & 0 & 1\end{matrix} ]$$

$${T}_{wg}^{j} = - [ \begin{matrix}cos ( {θ}_{j} ) & sin ( {θ}_{j} ) & 0 \\ - sin ( {θ}_{j} ) & cos ( {θ}_{j} ) & 0 \\ 0 & 0 & 1\end{matrix} ] [ \begin{matrix}{ρ}_{j} cos ( {θ}_{j} ) \\ {ρ}_{j} sin ( {θ}_{j} ) \\ {z}_{j}\end{matrix} ]$$

Gripper-to-camera transformation (R_{gc}, T_{gc}) may be computed by the controller 111 so that the re-projection error of measured points is minimized.

$${min}_{\{ {R}_{gc} , {T}_{gc} \}} {{\sum }_{i = 1 , … , m}}_{j = 1 , … , n} {‖ {I}_{i}^{j} - {\hat{I}}_{i}^{j} ‖}^{2} where {\hat{I}}_{i}^{j} = ( {\hat{u}}_{i}^{j} , {\hat{v}}_{i}^{j} )$$

is an estimated image measurement of point Pᵢ, as determined by:

$$s [ \begin{matrix}{\hat{u}}_{i}^{j} \\ {\hat{v}}_{i}^{j} \\ 1\end{matrix} ] = K ( {R}_{gc} ( {R}_{wg}^{j} {P}_{i} + {T}_{wg}^{j} ) + {T}_{gc}$$

and Iᵢ^{j}=(uᵢ^{j},vᵢ^{j}) is the detected target point in images, K the internal matrix, and s a scalar. The objective function is a nonlinear least-squares minimization problem and can be solved using, for example, Levenberg-Marquardt method. Other minimization methods may be used, as well.

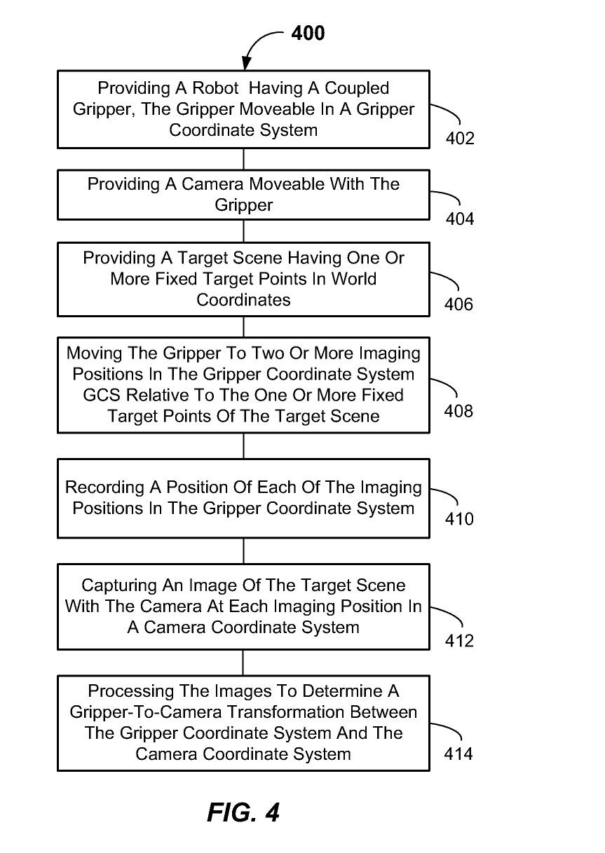

One method of calibrating a position of a gripper (e.g., gripper 104) of a robot (e.g., robot 102) to a camera (e.g., camera 106) may be carried out as follows. The method 400, as best shown in FIG. 4, includes providing, in 402, a robot (e.g., robot 102) having a coupled gripper (e.g., gripper 104), the gripper (e.g., gripper 104) moveable in a gripper coordinate system GCS, providing, in 404, a camera (e.g., camera 106) moveable with the gripper (e.g., gripper 104), and, in 406, providing a target scene (e.g., target scene 108) having one or more fixed target points (e.g., target points 210P, 211P, 212P, 214P) in a world coordinate system. The method further includes, in 408, moving the gripper (e.g., gripper 104) to two or more imaging locations in the gripper coordinate system GCS relative to the one or more fixed target points of the target scene (e.g., target scene 108), in 410, recording a position of each of the imaging locations in the gripper coordinate system, in 412, capturing an image of the target scene (e.g., target scene 108) with the camera (e.g., camera 106) at each imaging position in a camera coordinate system CCS, and, in 414, processing the images to determine a gripper-to-camera transformation between the gripper coordinate system and the camera coordinate system. FIG. 2D illustrates a diagram of pixel locations of target points (e.g., target points 210P, 211P, 212P, 214P) in various images captured from multiple imaging locations according to embodiments. The same target points (e.g., target points 210P, 211P, 212P, 214P) are designated by different symbols and the images are taken at different imaging locations in X, Y and Z space in the camera coordinate system CCS. Twelve imaging locations were used in this example. Not all target points are viewable in the field of view of the camera 106 at all the imaging locations. These pixel locations are used in the minimization technique to determine the gripper-to-camera transformation.

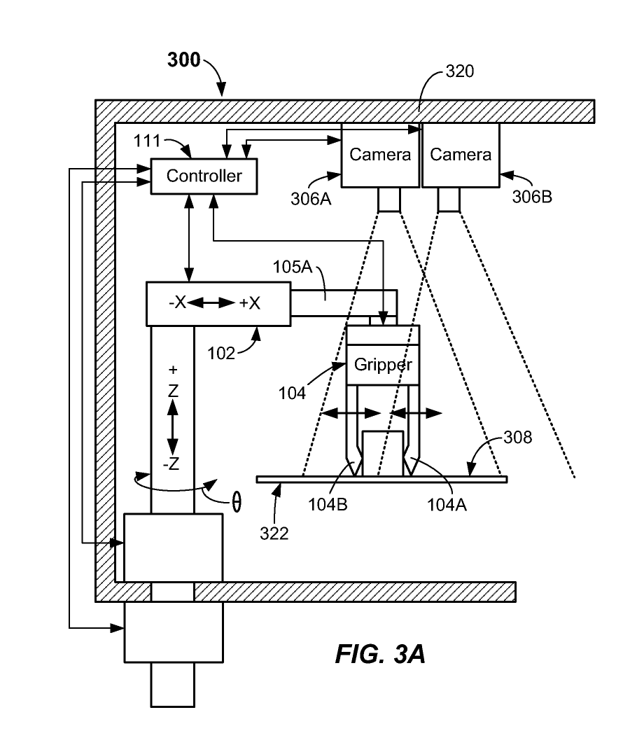

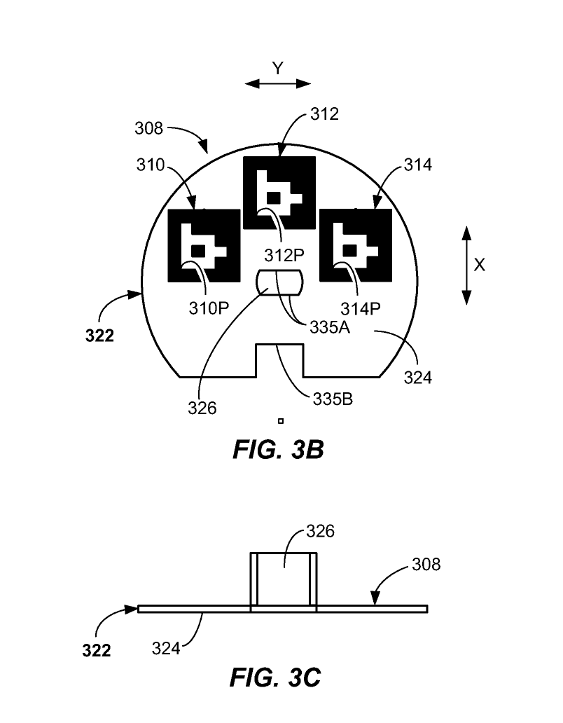

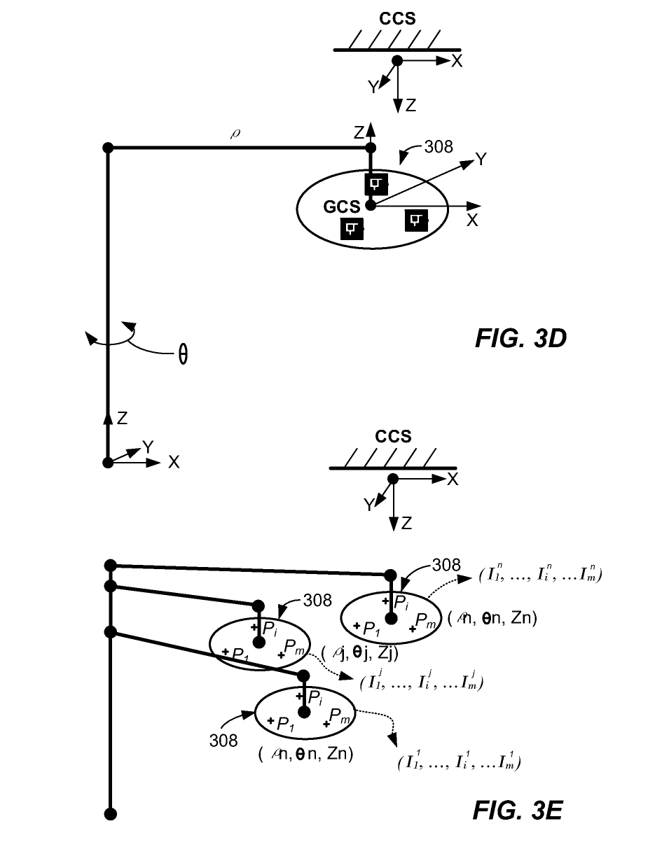

Another embodiment of a robot calibration apparatus 300 is shown and described with reference to FIGS. 3A-3C. The robot calibration apparatus 300 includes a frame 320 and a robot 102 moveable relative to the frame 320. The robot 102 may be physically coupled to the frame 320. The robot 102 has a gripper 104, and the robot 102 is adapted to cause motion of the gripper 104 in a gripper coordinate system GCS as previously described. In this embodiment, the target scene 308, including one or more fixed target points thereon, is moveable with the gripper 104. In the depicted embodiment, the target scene 308 is provided on a tool 322 that may be grasped by the gripper 104.

The tool 322 may include a disc 324 and an attached grasping member 326 such as the truncated cylindrical post shown. As shown in FIG. 3B, the target scene 308 may be made up of one or more targets. A plurality of targets 310, 312, 314 are provided in the target scene 308 in the depicted embodiments. Each of the targets 310, 312, 314 may include one or more fixed target points (e.g., 310P, 312P, 314P) that may be readily identifiable by image analysis and for which the X and Y coordinates may be determined in the gripper coordinate system GCS. The targets 310, 312, 314 may be placed on the tool 322 in a known orientation and location. The tool 322 may include an orientation feature 335A, such as flats on the grasping member 326. Optionally, a portion of the disc 324 may be removed to form an orientation feature 335B and the disc 324 may be picked up from a fixture that registers on an orientation feature 335B, such that the tool 322 may be grasped by the gripper 104 in an already-known orientation.

Again referring to FIG. 3A, one or more cameras 306A, 306B may be provided in a fixed orientation to the frame 320. For example, the cameras 306A, 306B may be mounted to a ceiling portion of the frame 320. The cameras 306A, 306B may be focused approximately at the location of the target scene 308. Cameras 306A, 306B may be configured and adapted to capture multiple images of the target scene 308 in a camera coordinate system CCS and store the same in digital format. A controller 111 is coupled to the one or more cameras 306A, 306B and the robot 102, and the controller 111 is adapted to process the images and positional information of the robot 102 to determine a gripper 104 to camera 306A, 306B transformation between the gripper coordinate system GCS and the camera coordinate system CCS. Again, the transformation may be by any suitable minimization method.

For example, as shown in FIG. 3D, the world coordinate system WCS, gripper coordinate system GCS, and camera coordinate system CCS are shown. The world coordinate system is fixed. The gripper coordinate system GCS will move when the robotic arm 105A moves to different locations, as parameterized by the robot parameters (X, θ, Z). For the stationary camera embodiment, the camera coordinate system CCS is also fixed. The goal is to recover the unknown rigid motion between the WCS and the CCS, (R_{wc}, T_{wc}). For an image location (e.g., the origin of the gripper coordinate system GCS), if the associated robot parameter is (ρ, θ, Z), where ρ is motion in the X direction, then the origin of the gripper coordinate system GCS in the world coordinate system is:

$${C}_{w} = [ \begin{matrix}ρ cos ( θ ) \\ ρ sin ( θ ) \\ z\end{matrix} ]$$

According to the method, a calibration device such as a disk 324 with multiple targets 310, 312, 314 (e.g., markers) is provided. Coordinates of these multiple targets 310, 312, 314 are fixed in the gripper coordinate system GCS and are known:

{P₁, . . . ,Pᵢ, . . . Pₘ}

When the robotic arm 105A moves, we can represent the motion in the world coordinate system WCS by concatenation with the robot parameters:

(ρⱼ,θⱼ,zⱼ)

These points are then imaged at several imaging locations in the fixed camera coordinate system CCS to obtain the images:

{I₁^{j}, . . . ,Iᵢ^{j}, . . . Iₘ^{j}}

For

j=1, . . . ,n.

FIG. 3E illustrates the gripper with carried target scene 308 being moved to multiple image locations in three-dimensional space.

When the robotic arm 105A moves to a location with parameter

(ρⱼ,θⱼ,zⱼ)

the rigid transformation from the gripper coordinate system GCS to the world coordinate system WCS can be determined as:

$${R}_{gw}^{j} = [ \begin{matrix}cos ( {θ}_{j} ) & - sin ( {θ}_{j} ) & 0 \\ sin ( {θ}_{j} ) & cos ( {θ}_{j} ) & 0 \\ 0 & 0 & 1\end{matrix} ]$$

$${T}_{gw}^{j} = [ \begin{matrix}{ρ}_{j} cos ( {θ}_{j} ) \\ {ρ}_{j} sin ( {θ}_{j} ) \\ {z}_{j}\end{matrix} ]$$

Gripper-to-camera transformation (R_{gc}, T_{gc}) changes as the robotic arm 105A and gripper 104 moves to different imaging locations. It can be characterized as a concatenation of two transformations. The first is from the gripper coordinate system GCS to the world coordinate system WCS, which can be derived from the robot parameters as described above. The second one is from the world coordinate system WCS to the camera coordinate system CCS, which is a rigid transformation. This transformation may be estimated. Assume the fixed target points (P₁, . . . , Pᵢ, . . . , Pₘ) are represented in the gripper coordinate system GCS. The unknown transformation between the world coordinate system WCS and the camera coordinate system CCS can be computed so that the re-projection error of measured points is minimized:

$${min}_{\{ {R}_{wc} , {T}_{wc} \}} {{\sum }_{i = 1 , … , m}}_{j = 1 , … , n} {‖ {I}_{i}^{j} - {\hat{I}}_{i}^{j} ‖}^{2}$$

where Îᵢ^{j}=(ûᵢ^{j},\hat{v}ᵢ^{j}) is estimated image measurement of point Pᵢ, as determined by:

$$s [ \begin{matrix}{\hat{u}}_{i}^{j} \\ {\hat{v}}_{i}^{j} \\ 1\end{matrix} ] = K ( {R}_{wc} ( {R}_{gw}^{j} {P}_{i} + {T}_{gw}^{j} ) + {T}_{wc} )$$

and Iᵢ^{j}=(uᵢ^{j},vᵢ^{j}) is detected fixed target point (e.g., marker corner point) in the images, K the internal matrix, and s a scalar. The objective function is a nonlinear, least-squares minimization problem and can be solved using, for example, the Levenberg-Marquardt method.

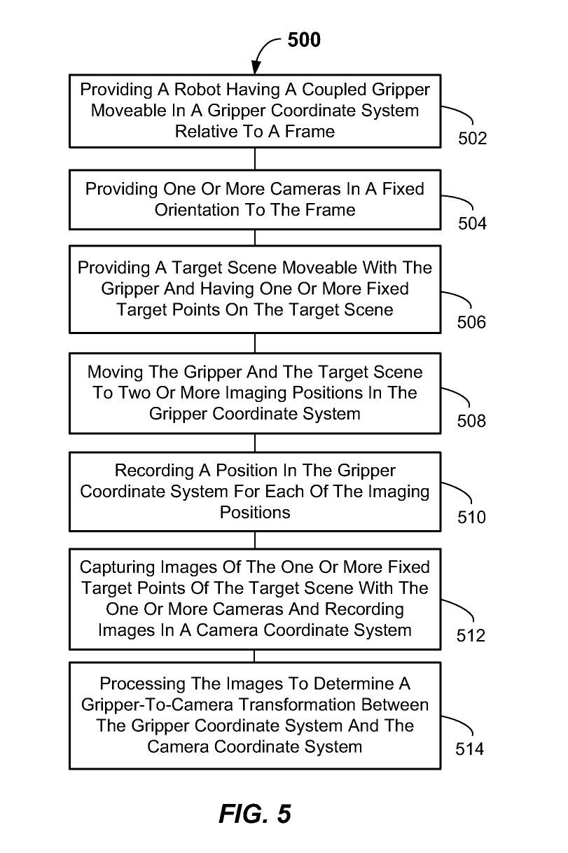

Another method of calibrating a position of a gripper (e.g., gripper 104) of a robot (e.g., robot 102) to a camera (e.g., camera 306A) may be carried out as follows. The method 500, as best shown in FIG. 5, includes providing, in 502, a robot having a coupled gripper moveable in a gripper coordinate system relative to a frame, providing, in 504, one or more cameras in a fixed orientation to the frame, and providing, in 506, a target scene moveable with the gripper and having one or more fixed target points on the target scene. The method 500 also includes, in 508, moving the gripper and the target scene relative to the frame to two or more imaging locations in the gripper coordinate system, recording, in 510, a position in the gripper coordinate system for each of the imaging locations, and capturing images, in 512, of the one or more fixed target points of the target scene with the one or more cameras and recording images in a camera coordinate system. Finally, the method 500 includes processing the images, in 514, to determine a gripper-to-camera transformation between the gripper coordinate system and the camera coordinate system.

While the invention is susceptible to various modifications and alternative forms, specific system and apparatus embodiments and methods thereof have been shown by way of example in the drawings and are described in detail herein. It should be understood, however, that it is not intended to limit the invention to the particular systems, apparatus, or methods disclosed but, to the contrary, the intention is to cover all modifications, equivalents, and alternatives falling within the scope of the invention.

What is claimed is:

1. A method of calibrating a position of a gripper to a camera, comprising:
providing a robot having a coupled gripper, the gripper moveable in a gripper coordinate system;
providing a camera moveable with the gripper;
providing a target scene having one or more fixed target points in world coordinates;
moving the gripper to two or more imaging locations in the gripper coordinate system relative to the one or more fixed target points of the target scene;
recording a position of each of the imaging locations in the gripper coordinate system;
capturing an image of the target scene with the camera at each imaging position in a camera coordinate system; and
processing the images to determine a gripper-to-camera transformation between the gripper coordinate system and the camera coordinate system.

2. The method of claim 1, wherein the target scene comprises at least two fixed target points in a world coordinate system.

3. The method of claim 1, wherein the moving the gripper to multiple imaging locations comprises moving the camera above one or more targets of the target scene.

4. The method of claim 3, wherein the one or more targets of the target scene comprise image markers.

5. The method of claim 4, wherein the image markers comprise intersecting lines forming fixed target points.

6. The method of claim 1, wherein the moving the gripper to multiple imaging locations comprises moving the camera to two or more vertical heights and capturing images thereat.

7. The method of claim 1, wherein the moving the gripper to multiple imaging locations comprises moving the gripper to ten or more imaging locations at different X, Y, and Z locations in the gripper coordinate system.

8. The method of claim 1, wherein the processing of the images comprises detecting fixed corner points in the images.

9. The method of claim 1, further comprising determining the gripper-to-camera transformation by nonlinear, least-squares minimization.

10. The method of claim 9, further comprising determining the gripper-to-camera transformation by Levenberg-Marquardt method.

11. A robot calibration apparatus, comprising:
a robot having a gripper, the robot adapted to cause motion of the gripper in a gripper coordinate system;
a target scene including one or more fixed target points;
a camera moveable with the gripper and adapted to capture images of the target scene in a camera coordinate system; and
a controller coupled to the camera and the robot, the controller adapted to process the images and positional information of the robot to determine a gripper-to-camera transformation between the gripper coordinate system and the camera coordinate system.

12. A method of calibrating a position of a gripper to a camera, comprising:
providing a robot having a coupled gripper moveable in a gripper coordinate system relative to a frame;
providing one or more cameras in a fixed orientation to the frame;
providing a target scene moveable with the gripper and having one or more fixed target points on the target scene;
moving the gripper and the target scene to two or more imaging locations in the gripper coordinate system;
recording a position in the gripper coordinate system for each of the imaging locations;
capturing images of the one or more fixed target points of the target scene with the one or more cameras and recording images in a camera coordinate system; and
processing the images to determine a gripper-to-camera transformation between the gripper coordinate system and the camera coordinate system.

13. The method of claim 12, wherein the one or more fixed target points are provided on an image marker on a disc carried by the gripper.

14. The method of claim 12, wherein the one or more fixed target points are provided on a target scene comprising multiple image markers.

15. The method of claim 12, wherein the target scene is carried by the gripper.

16. The method of claim 12, wherein the moving the gripper to two or more imaging locations comprises moving the gripper to two or more vertical heights and capturing images thereat.

17. The method of claim 12, wherein the moving the gripper to the two or more imaging locations comprises moving the gripper to ten or more imaging locations.

18. The method of claim 11, wherein the processing of the images comprises detecting the fixed target points in the images.

19. A robot calibration apparatus, comprising:
a frame;
a robot moveable relative to the frame and having a gripper, the robot adapted to cause motion of the gripper in a gripper coordinate system;
a fixed target scene including one or more fixed target points moveable with the gripper;
one or more cameras provided in a fixed orientation to the frame and adapted to capture images of the target scene in a camera coordinate system; and
a controller coupled to the one or more cameras and the robot, the controller adapted to process the images and positional information of the robot to determine a gripper-to-camera transformation between the gripper coordinate system and the camera coordinate system.
